(19) United States
(12) Patent Application Publication
(10) Pub. No.: US 2013/0222554 A1
(43) Pub. Date: Aug. 29, 2013

(54) IMAGE PROCESSING APPARATUS AND METHOD, IMAGE PROCESSING SYSTEM, AND PROGRAM

(71) Applicants: Hiroshi Hayashi, Kanagawa (JP); Yasushi Fukuda, Kanagawa (JP); Minoru Kaihatsu, Kanagawa (JP)

(72) Inventors: Hiroshi Hayashi, Kanagawa (JP); Yasushi Fukuda, Kanagawa (JP); Minoru Kaihatsu, Kanagawa (JP)

(73) Assignee: Sony Corporation, Tokyo (JP)

(21) Appl. No.: 13/591,422

(22) Filed: Aug. 22, 2012

(30) Foreign Application Priority Data
Aug. 29, 2011 (JP) 2011-185719

(51) Int. Cl. H04N 13/02

(52) U.S. Cl. CPC H04N 13/021
USPC 348/50

(57) ABSTRACT

An image processing apparatus for adjustment of relative positions of a plurality of images of the same subject includes: a storage controller configured to store pixel data of pixels of an input image in a buffer, the input image being included in the images including a reference image, the input image differing from the reference image in that the subject of the input image is misaligned from the subject of the reference image by a given angle; a readout unit configured to read out, from the buffer, the pixel data of the pixels of the input image that fall in a region of the input image when rotated by the given angle, and a pixel data computing unit configured to calculate pixel data of pixels constituting a rotated image, which includes the input image rotated by the given angle, based on the pixel data read out by the readout unit.

### BACKGROUND

The present technology relates to image processing apparatus and method, an image processing system, and a program. In particular, the present technology relates to image processing apparatus and method, an image processing system, and a program for low cost and low latency adjustment in relative position of a plurality of images captured by a plurality of cameras without any influence of aged deterioration.

For a distance measurement using a disparity between two images captured by a stereo camera, it is necessary that the images be correctly aligned. A position of each of cameras in mechanical design is theoretically known. However, there are product-by-product variations in deviation in position of the cameras due to fabrication errors and the like. Thus, it is necessary to measure such deviations individually and correct positional misalignment between two images (make adjustment for relative positions of two images) captured by two cameras based on the measured deviations.

A mechanical method and a frame memory method are known methods of adjusting relative positions of images.

The mechanical method is a technique of physically adjusting the positions of cameras by a mechanical structure to adjust relative positions of images. For example, a stereo camera is known (e.g., see Japanese Patent Application Laid-open No. 2008-45983), in which, using a reference image captured by one of two cameras and a subject image captured by the other camera, the other camera is moved in accordance with the position of the subject image relative to the reference image.

According to the frame memory method, images from two cameras are once stored in frame memories, respectively. In accordance with positional misalignment of the images stored in the frame memories, read addresses for one of the frame memories are operated to adjust relative positions of the images (e.g., see Japanese Patent Application Laid-open No. Hei 06-273172).

### SUMMARY

Incidentally, since a driver apparatus such as a motor for moving the cameras is necessary in the mechanical method, manual adjustment of them has been performed in the manufacturing process of stereo cameras.

Such manufacturing process of stereo cameras requires equipment investment and time therefor, causing an increase in cost of production. In addition, there has been a high possibility that the stereo cameras applying the mechanical method may be adversely affected by an influence of aged deterioration.

On other hand, the frame memory method suffers from not only a very high expenditure on frame memories but also high latency in processing. For stereo matching in particular, memories for delay adjustment are used for keeping simultaneity of images, causing another very high expenditure.

Considering this situation, the present technology enables low cost and low latency adjustment in relative position of a plurality of images captured by a plurality of cameras without any influence of aged deterioration.

According to one embodiment of the present technology, there is provided an image processing apparatus for adjustment of relative positions of a plurality of images of the same subject, the image processing apparatus including: a storage controller configured to store pixel data of pixels of an input image in a buffer, the input image being included in the plurality of images including a reference image that is a standard for the other images, the input image differing from the reference image in that the subject of the input image is misaligned from the subject of the reference image by a given angle; a readout unit configured to read out, from the buffer, the pixel data of the pixels of the input image that fall in a region of the input image when rotated by the given angle, the region corresponding to the reference image; and a pixel data computing unit configured to calculate pixel data of pixels constituting a rotated image, which includes the input image rotated by the given angle, based on the pixel data read out by the readout unit.

The pixels of the input image that fall in the region may be scanned before corresponding pixels of the reference image are scanned.

The readout unit may read out from the buffer the pixel data of 2×2 adjacent pixels that are in the region of the input image and correspond to a pixel position of one pixel constituting the rotated image.

The storage controller may store the pixel data of the pixels of the input image one line after another in the buffer.

The storage controller may store the pixel data of the pixels of the input image one after another of pixel blocks in the buffer, each of the pixel blocks containing a given number of pixels constituting one line of the rotated image.

In a case where a line of pixels to be stored of the input image corresponds to a line of pixels of the rotated image that correspond to pixels to be read out in the input image, the storage controller may delay storing pixel data of the pixels of the input image one after another of the pixel blocks in the buffer.

The image processing apparatus may further include a pixel data output unit configured to output, as pixel data of pixels constituting the rotated image, pixel data of pixels falling a region in the reference image, the region falling outside the region of the input image when rotated by the given angle.

The image processing apparatus may further include a position adjustment unit configured to rectify a positional misalignment in xy directions in the input image with respect to the reference image.

According to another embodiment of the present technology, there is provided an image processing method for an image processing apparatus used for adjustment of relative positions of a plurality of images of the same subject, the image processing method including: storing pixel data of pixels of an input image in a buffer, the input image being included in the plurality of images including a reference image that is a standard for the other images, the input image differing from the reference image in that the subject of the input image is misaligned from the subject of the reference image by a given angle; reading out, from the buffer, the pixel data of the pixels of the input image that fall in a region of the input image when rotated by the given angle, the region corresponding to the reference image; and calculating pixel data of pixels constituting a rotated image, which includes the input image rotated by the given angle, based on the pixel data read out.

According to still another embodiment of the present technology, there is provided a program causing a computer to perform image processing for adjustment of relative positions of a plurality of images of the same subject, the program causing the computer to execute the steps of: storing pixel data of pixels of an input image in a buffer, the input image being included in the plurality of images including a reference image that is a standard for the other images, the input image differing from the reference image in that the subject of the input image is misaligned from the subject of the reference image by a given angle; reading out, from the buffer, the pixel data of the pixels of the input image that fall in a region of the input image when rotated by the given angle, the region corresponding to the reference image; and calculating pixel data of pixels constituting a rotated image, which includes the input image rotated by the given angle, based on the pixel data read out by the reading out from the buffer.

According to still another embodiment of the present technology, there is provided an image processing system for adjustment of relative positions of a plurality of images of the same subject, the image processing system including: a plurality of cameras configured to capture a plurality of images of the same subject; and an image processing apparatus including a storage controller configured to store pixel data of pixels of an input image in a buffer, the input image being included in the plurality of images including a reference image that is a standard for the other images, the input image differing from the reference image in that the subject of the input image is misaligned from the subject of the reference image by a given angle, a readout unit configured to read out, from the buffer, the pixel data of the pixels of the input image that fall in a region of the input image when rotated by the given angle, the region corresponding to the reference image, and a pixel data computing unit configured to calculate pixel data of pixels constituting a rotated image, which includes the input image rotated by the given angle, based on the pixel data read out by the readout unit.

According to the embodiments of the present technology, the pixel data of the pixels of the input image, in which the subject is misaligned by the given angle with respect to the reference image as a standard for the other images, are stored in the buffer, the pixel data of the pixels of the input image that fall in a region of the input image when rotated by the given angle are read out from the buffer, the region corresponding to the reference image, and pixel data of pixels constituting a rotated image, which includes the input image rotated by the given angle, are calculated based on the pixel data read out.

According to the embodiments of the present technology, low cost and low latency adjustment in relative positions of a plurality of images captured by a plurality of cameras is enabled without any influence of aged deterioration.

### BRIEF DESCRIPTION OF DRAWINGS

FIG. 1 is a block diagram illustrating a functional structure example of an image processing apparatus according to an embodiment of the present technology;

FIGS. 2A, 2B and 2C are diagrams for describing rotational misalignment of an image;

FIG. 3 is a diagram for describing the correspondence between pixels of an image before rotation and pixels of the rotated image;

FIGS. 4A, 4B and 4C are diagrams for describing rotational misalignment of an image;

FIG. 5 is a diagram for describing the correspondence between pixels of an image before rotation and pixels of the rotated image;

FIG. 6 is a flowchart for describing position adjustment processing by the image processing apparatus shown in FIG. 1;

FIG. 7 is a diagram for describing one example of storing and reading out pixel data in and from a buffer;

FIG. 8 is a diagram for describing calculation of pixel data constituting an output image;

FIG. 9 is a diagram for describing another example of storing and reading out pixel data in and from a buffer;

FIG. 10 is a diagram for describing still another example of storing and reading out pixel data in and from a buffer;

FIG. 11 is a block diagram illustrating a functional structure example of an image processing apparatus according to another embodiment of the present technology;

FIG. 12A, 12B and 12C are schematic diagrams for describing positional misalignment in xy directions of an image;

FIG. 13 is a flowchart for describing position adjustment processing by the image processing apparatus shown in FIG. 11; and

FIG. 14 is a block diagram illustrating a structural example of hardware of a computer.

### DETAILED DESCRIPTION OF EMBODIMENTS

First, positional misalignment of images is mainly caused due to three components as follows:

(1) Positional misalignment in xy directions;

(2) Positional misalignment in rotation direction; and

(3) Magnification mismatches.

Among them, (1) positional misalignment in xy directions and (2) positional misalignment in rotation direction are highly effective in adjustment of positions of images. The present specification focuses on “positional misalignment in rotation direction” in particular.

Hereinafter, embodiments of the present technology will be described with reference to the drawings. Now, the description is given in the following order:

1. The structure and operation of an image processing apparatus according to an embodiment of the present technology;

2. Example 1 of storing pixel data into a buffer and reading out the pixel data from the buffer;

3. Example 2 of storing pixel data into a buffer and reading out the pixel data from the buffer;

4. Example 3 of storing pixel data into a buffer and reading out the pixel data from the buffer; and

5. Another structure and operation of an image processing apparatus according to another embodiment of the present technology.

### <1. The Structure and Operation of an Image Processing Apparatus According to an Embodiment of the Present Technology>

### [The Structure of an Image Processing Apparatus]

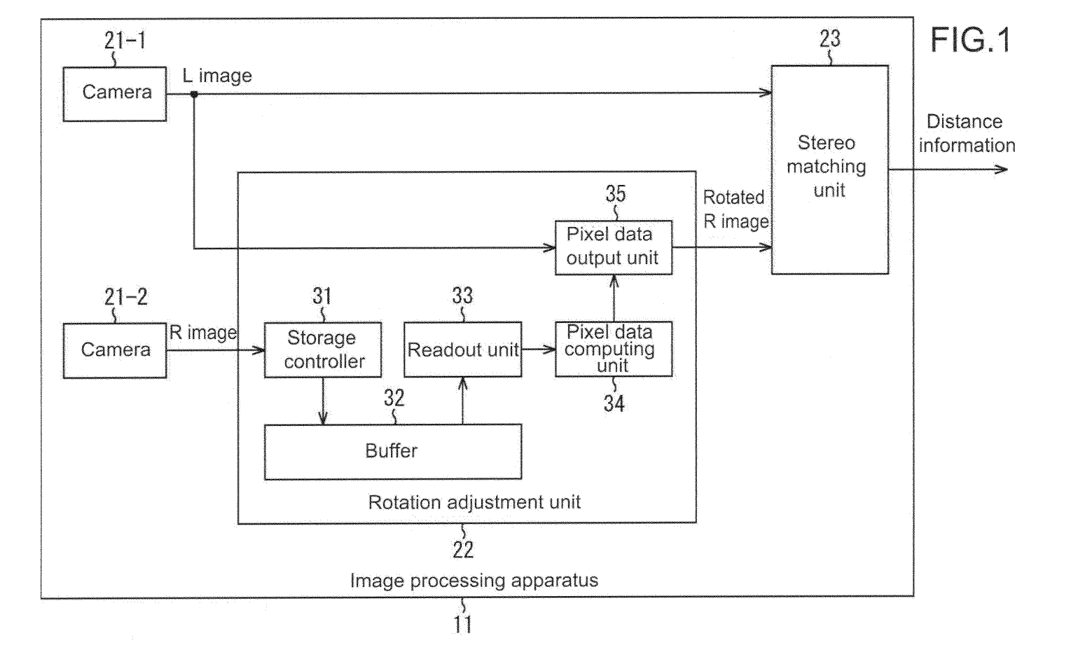

FIG. 1 illustrates a structure of an image processing apparatus (or image processing system) according to an embodiment of the present technology.

An image processing apparatus 11 shown in FIG. 1 is configured, as a so-called stereo camera, to acquire two images of the same subject for extraction of disparity, specifying a position of the subject in a depth direction according to stereo matching to provide distance information indicating a distance to the subject.

The image processing apparatus 11 shown in FIG. 1 includes cameras 21-1 and 21-2, a rotation adjustment unit 22, and a stereo matching unit 23.

The cameras 21-1 and 21-2 take images of the same subject from right and left different viewpoints. The camera 21-1 feeds a left side image (hereinafter called L image) to the rotation adjustment unit 22 and the stereo matching unit 23. The camera 21-2 feeds a right side image (hereinafter called R image) to the rotation adjustment unit 22.

It should be noted that the cameras 21-1 and 21-2 may have any structure as long as they can take images from different viewpoints, so they may take images from different viewpoints not in a right and left or horizontal direction but in an up and down or vertical direction, for example. Further, since the cameras 21-1 and 21-2 may have any structure so as to take images from a plurality of different viewpoints, images to be used may not be images taken by two cameras from two different viewpoints, but a plurality of images taken by more than two cameras from more than two different viewpoints. However, for convenience of explanation, two cameras 21-1 and 21-2 that take two images from different viewpoints in the right and left direction are explained in the following description.

The rotation adjustment unit 22 uses the L image fed by the camera 21-1 as an image that is a standard for the other (called a reference image), measures rotational misalignment of the R image fed by the camera 21-2 relative to the L image, and feeds to the stereo matching unit 23 a rotated R image in which a rotation angle corresponding to the rotational misalignment is adjusted.

### [Rotational Misalignment of Image]

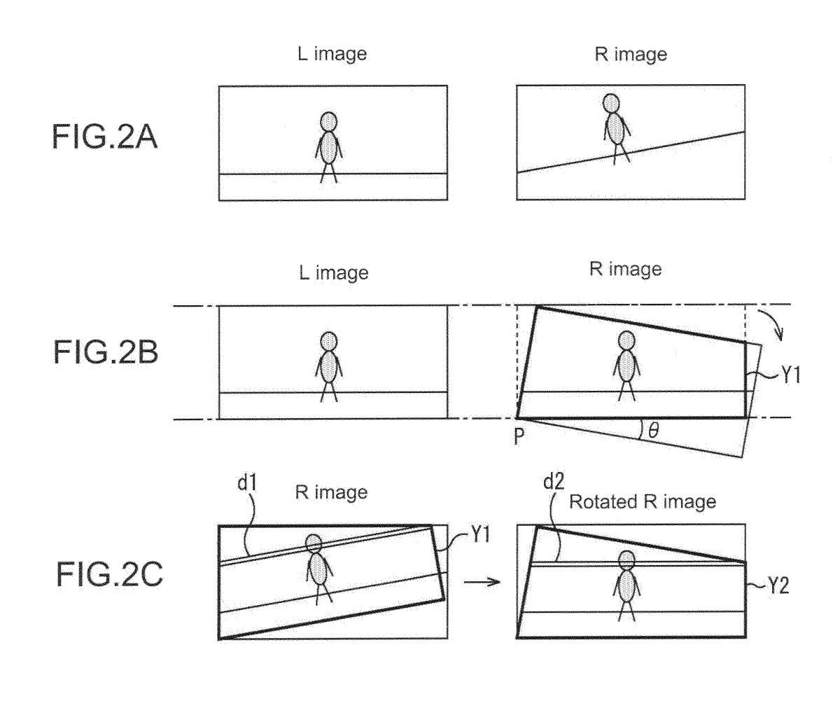

Now, referring to FIGS. 2A, 2B and 2C, rotational misalignment of the R image relative to the L image will be explained.

FIG. 2A illustrates the L image taken by the camera 21-1 and the R image taken by the camera 21-2. As seen in FIG. 2A, assuming that the subject of the L image is a reference, the subject of the R image is inclined to the left with respect to the subject of the L image (or misaligned by a given angle).

FIG. 2B illustrates the L image in the same position as in FIG. 2A and the R image obtained by rotating the R image of FIG. 2A to adjust the inclination (rotational misalignment) of the subject in the R image of FIG. 2A by an angle θ corresponding to the misalignment. As seen from FIG. 2B, the R image is rotated with a point P as the center of the rotation to the right or clockwise by the angle θ, so that the rotational misalignment between the subject in the R image and the subject in the L image is rectified. It is assumed now that there is no positional misalignment in the xy directions between the L image and the R image.

As highlighted by the fully drawn bold lines in FIG. 2B, a partial region Y1 of the R image, which has been assumed after its rotation with the point P as the center of the rotation to the right or clockwise by the angle 6, corresponds to the L image.

Referring to FIG. 2C, this allows the rotation adjustment unit 22 to use the partial region Y1 of the R image before rotation with the point P as the center of the rotation as a partial region Y2 of a rotated R image obtained after the rotation, to get most of the rotated R image. More specifically, pixel data of pixels constituting a line segment d2 of the partial region Y2 in the rotated R image obtained after the rotation are computed based on pixel data of pixels constituting a line segment d1 of the partial region Y1 in the R image before the rotation.

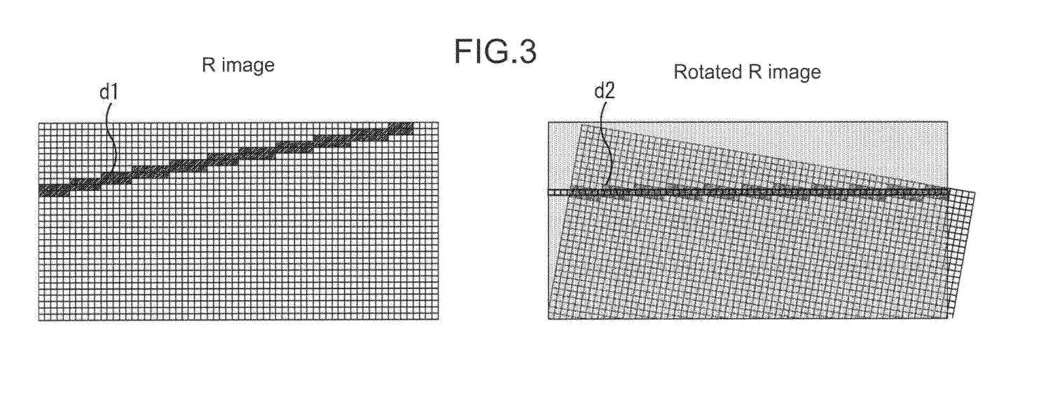

As shown in FIG. 3, in the R image before the rotation with the point P as the center of the rotation, the line segment d1 is given by pixel blocks, each of which includes 5 or 6 pixels in a pixel direction (in a direction to the right in FIG. 3) by 2 pixels in a line direction (in a downward direction in FIG. 3) and arranged in the upper right oblique direction. This enables calculation of pixel data constituting the line segment d2 in the rotated R image obtained after the rotation, based on pixel data of the pixel blocks constituting the line segment d1 in the corresponding R image before the rotation with the point P as the center of the rotation.

In addition, in the rotated R image shown in FIG. 2C, pixel data of regions excluding the partial region Y2, hereinafter called “blank regions”, are filled up by pixel data of the corresponding pixels in the L image.

Each of the L image and the R image is scanned from the upper left pixels to the lower right pixels, but pixels constituting the partial region Y1, which is set in accordance with where the point P as the center of rotation is located and the direction of rotation that are shown in FIGS. 2, of the R image are scanned before pixels of the corresponding L image are scanned.

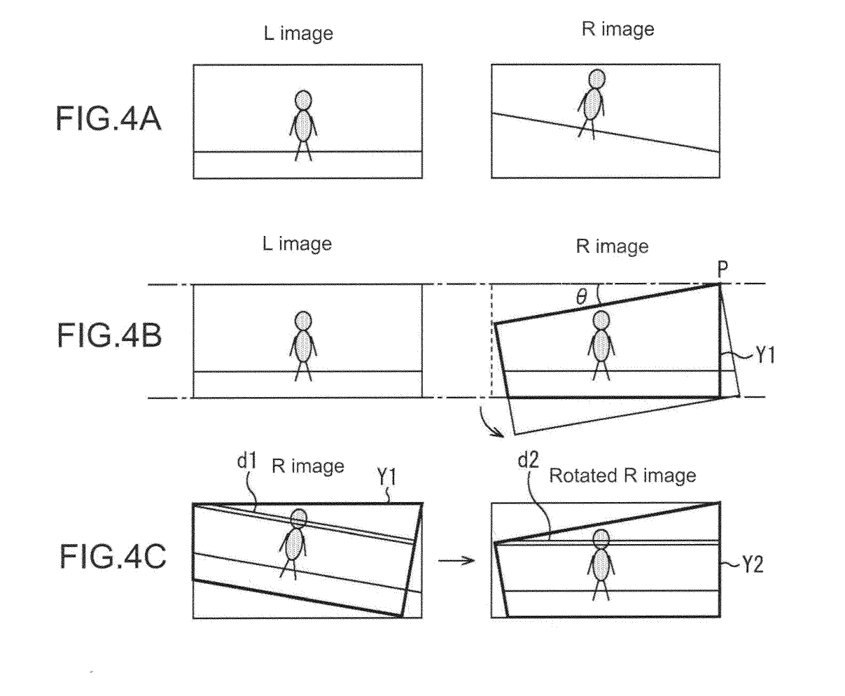

FIGS. 4A, 4B and 4C are diagrams for describing rotational misalignment of the R image relative to the L image in the opposite direction to the direction of FIGS. 2A, 2B and 2C.

FIG. 4A illustrates the L image taken by the camera 21-1 and the R image taken by the camera 21-2. As seen in FIG. 4A, assuming that the subject of the L image is a reference, the subject of the R image is inclined to the right with respect to the subject of the L image (or misaligned by a given angle).

FIG. 4B illustrates the L image in the same position as in FIG. 4A and the R image obtained by rotating the R image of FIG. 4A to adjust the inclination (rotational misalignment) of the subject in the R image of FIG. 4A by an angle θ corresponding to the misalignment. As seen from FIG. 4B, the R image is rotated with a point P as the center of the rotation to the left or counterclockwise by the angle θ, so that the rotational misalignment between the subject in the R image and the subject in the L image is rectified. It is assumed now that there is no positional misalignment in the xy directions between the L image and the R image.

As highlighted by the fully drawn bold lines in FIG. 4B, a partial region Y1 of the R image, which has been assumed after its rotation with the point P as the center of the rotation to the left or counterclockwise by the angle θ, corresponds to the L image.

Referring to FIG. 4C, this allows the rotation adjustment unit 22 to use the partial region Y1 of the R image before rotation with the point P as the center of the rotation as a partial region Y2 of a rotated R image obtained after the rotation, to get most of the rotated R image. More specifically, pixel data of pixels for a line segment d2 of the partial region Y2 in the rotated R image obtained after the rotation are computed based on pixel data of pixels constituting a line segment d1 of the partial region Y1 in the R image before the rotation.

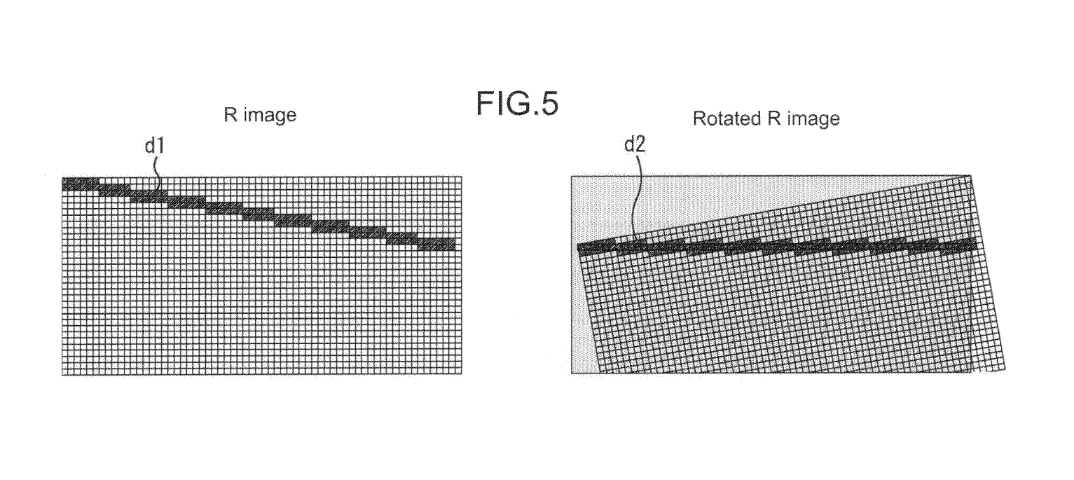

As shown in FIG. 5, in the R image before the rotation with the point P as the center of the rotation, the line segment d1 is given by pixel blocks, each of which includes 5 or 6 pixels in a pixel direction (in a direction to the right in FIG. 5) by 2 pixels in a line direction (in a downward direction in FIG. 5), and arranged in the lower right oblique direction. This enables calculation of pixel data constituting the line segment d2 in the rotated R image obtained after the rotation, based on pixel data of the pixel blocks constituting the line segment d1 in the corresponding R image before the rotation with the point P as the center of the rotation.

It should be noted that in the rotated R image shown in FIG. 4C, pixel data of regions excluding the partial region Y2 (or blank regions) are filled up by pixel data of the corresponding pixels in the L image.

Each of the L image and the R image is scanned from the upper left pixels to the lower right pixels, but pixels constituting the partial region Y1, which is set in accordance with where the point P as the center of rotation is located and the direction of rotation that are shown in FIGS. 4, of the R image are scanned before pixels of the corresponding L image are scanned.

In the above-mentioned manner, there is given the rotated R image in which a rotational angle corresponding to the rotational misalignment of the R image captured by the camera 21-2 is adjusted.

Turning back to FIG. 1, the rotation adjustment unit 22 includes a storage controller 31, a buffer 32, a readout unit 33, a pixel data computing unit 34 and a pixel data output unit 35.

The storage controller 31 sequentially stores pixel data of pixels in the R image from the camera 21-2 in the buffer 32.

The buffer 32, which is made of a memory such as a static random access memory (SRAM) or a dynamic random access memory (DRAM), stores the pixel data from the storage controller 31. The stored pixel data is read out by the readout unit 33.

The readout unit 33 reads out the pixel data of the pixels of the R image stored in the buffer 32 at a given timing. Specifically, the readout unit 33 reads out the pixel data of the pixels in the partial region Y1 (see FIG. 2 or 4) among the pixels of the R image stored in the buffer 32, and feeds them to the pixel data computing unit 34.

The pixel data computing unit 34 computes pixel data of pixels constituting the rotated R image based on the pixel data from the readout unit 33. Specifically, the pixel data computing unit 34 computes pixel data of pixels constituting the partial region Y2 in the whole pixels constituting the rotated R image based on the pixel data of the pixels of the partial region Y1 in the pixels of the R image, and feeds them to the pixel data output unit 35.

The pixel data output unit 35 feeds pixel data of the pixels constituting the rotated R image to the stereo matching unit 23. Specifically, the pixel data output unit 35 outputs pixel data of pixels corresponding to the blank regions of the rotated R image selected from the whole pixels of the L image from the camera 21-1 together with pixel data of pixels constituting the partial region Y2 of the rotated R image fed by the pixel data computing unit 34.

The stereo matching unit 23 outputs distance information indicating a distance to the subject after specifying the position of the subject in a depth direction by stereo matching based on the L image from the camera 21-1 and the rotated R image from the rotation adjustment unit 22.

According to the stereo matching, area correlation is carried out to determine which point in the L image captured by the camera 21-1 corresponds to a point in the R image captured by the camera 21-2, and the position of the subject in the depth direction is computed using triangulation based on the correspondence.

### [Position Adjustment Processing]

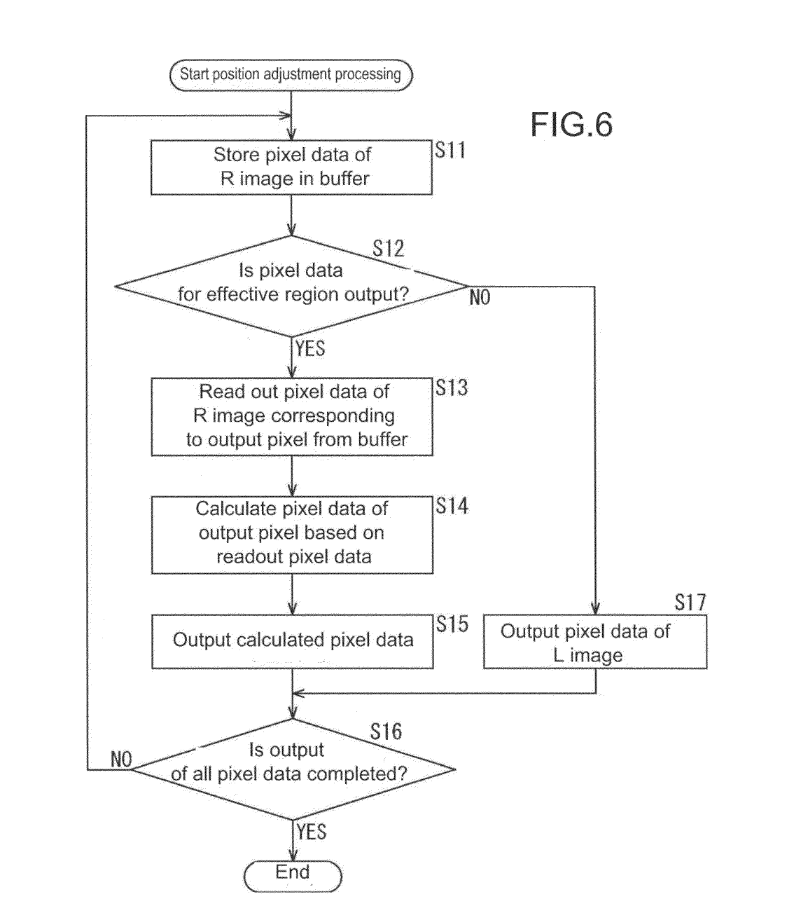

Referring, next, to the flowchart shown in FIG. 6, the position adjustment processing by the image processing apparatus 11 will be described. It is assumed in the position adjustment processing shown in FIG. 6 that there is no positional misalignment in xy directions between the L and R images.

In step S11, the storage controller 31 stores pixel data of pixels of the R image from the camera 21-2 in the buffer 32.

In step S12, the rotation adjustment unit 22 determines whether or not pixel data of pixels constituting the partial region Y2 (see FIG. 2 or 4), called hereinafter “effective region Y2”, of the rotated R image to be obtained is output. In the rotation adjustment unit 22, it is determined whether or not each pixel to be output (called “output pixel”) matches the corresponding pixel constituting the effective region Y2 based on the pixel position of each pixel in the R image from the camera 21-2 and the angle θ by which the R image is misaligned.

If it is determined in step 12 that the pixel data of the pixels of the effective region Y2 is output, the processing continues with step S13. In step S13, the readout unit 33 reads out pixel data of pixels, which correspond to the output pixels, in the partial region Y1 (see FIG. 2 or 4) of the R image from the buffer 32 and feeds them to the pixel data computing unit 34.

In step S14, the pixel data computing unit 34 computes pixel data of the output pixels based on the pixel data of pixels, which correspond to the output pixels, of the R image (i.e., its partial region Y1) from the readout unit 33 and feeds them to the pixel data output unit 35.

In step S15, the pixel data output unit 35 outputs the computed pixel data of the output pixels from the pixel data computing unit 34 to feed them to the stereo matching unit 23 and the processing continues with step S16.

On the other hand, if it is not determined in step 12 that the pixel data of the pixels of the effective region Y2 is output, the processing will continue with step S17. In step S17, the pixel data output unit 35 outputs the pixel data of pixels in the L image from the camera 21-1 which correspond to the output pixels, i.e., the pixel data of pixels in the L image which correspond to the blank regions of the rotated R image to feed them to the stereo matching unit 23 and the processing continues with step S16.

In step S16, the rotation adjustment unit 22 determines whether or not the output of all of the pixel data of the output pixels is completed. If it is not determined in step S16 that the output of all of the pixel data of the output pixels is completed, the processing continues with a loop beginning with the step S11 and repeats this loop till the completion of the output of all of the pixel data of the output pixels.

With the preceding processing, the pixel data of pixels of the R image from the camera 21-2 are stored in the buffer 32, the pixel data of those pixels which fall in the partial region Y1 of the R image are read out, and the pixel data of pixels of the rotated R image after its rotation (i.e., the effective region Y2) are calculated based on the readout pixel data. This makes it no longer necessary to physically adjust the camera position as in the mechanical method and to use a large capacity memory such as a frame memory, because the pixel data stored in the buffer 32 are read out sequentially. In other words, this enables low cost and low latency adjustment in relative positions of images captured by a plurality of cameras without any influence of aged deterioration.

It should be noted that the pixel data of those pixels which fall in the regions excluding the effective region Y2 (blank regions) in the rotated R image are the same as the corresponding pixel data of the pixels in the L image, so the stereo matching unit 23 determines that the disparity is zero in the blank regions.

<2. Example 1 of Storing Pixel Data into a Buffer and Reading Out the Pixel Data from the Buffer>

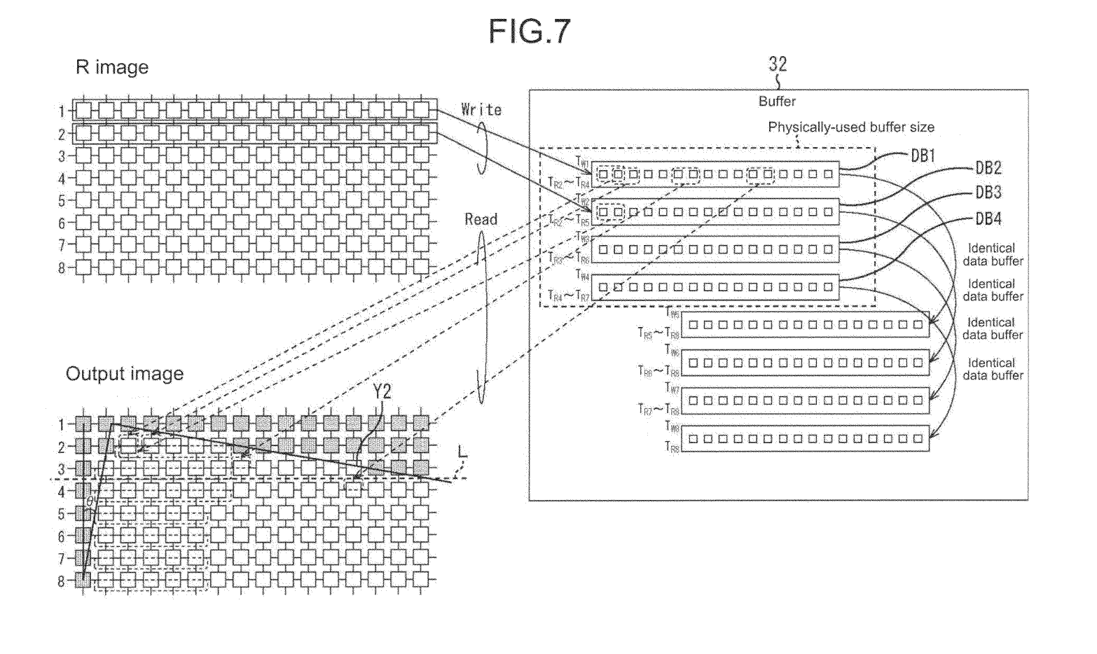

Referring now to FIG. 7, the detailed example of storing the pixel data in the buffer 32 and reading out them from the buffer 32 will be described.

In FIG. 7, the pixel data of the pixels in the R image captured by the camera 21-2 are stored in the buffer 32 line by line. Specifically, the pixel data on the first line in the R image are stored in a data buffer DB1. The pixel data on the second line in the R image are stored in a data buffer DB2. The pixel data on the third line in the R image are stored in a data buffer DB3. The pixel data on the fourth line are stored in a data buffer DB4.

On the other hand, the pixel data stored in the data buffers DB1 to DB4 are used for calculating pixel data of pixels represented by squares with a visible line and a transparent fill (pixels constituting the effective region Y2) among the pixels constituting the output image (rotated R image) and they are read out as needed. It should be noted that among all of the pixels constituting the output image, pixels represented by squares of shaded areas are pixels constituting the blank regions.

Here, T_{Wn} (where n is a natural number) near the upper left corner of each of the data buffers DB1 to DB4 represents a timing at which the pixel data on the nth line in the R image are stored (or written) in the corresponding one of the data buffers DB1 to DB4, and T_{Rn} near the lower left corner of each of the data buffers DB1 to DB4 represents a timing at which pixel data constituting the nth line in the output image are read out (or read) from the corresponding data buffer.

Thus, for example, the pixel data on the first line in the R image are stored in the data buffer DB1 at the timing T_{W1} and the stored pixel data are read out at the timings T_{R2} to T_{R4} for reading out pixel data constituting the second to fourth lines in the output image.

To calculate pixel data of a pixel (or an output pixel) in the output image, the pixel data to be read out from the buffer 32 is calculated based on the pixel data of the 2×2 adjacent pixels in the neighborhood of a pixel position in the R image which corresponds to the pixel position of the output pixel.

For example, pixel data of the third pixel P23 from the left on the second line of the output image shown in

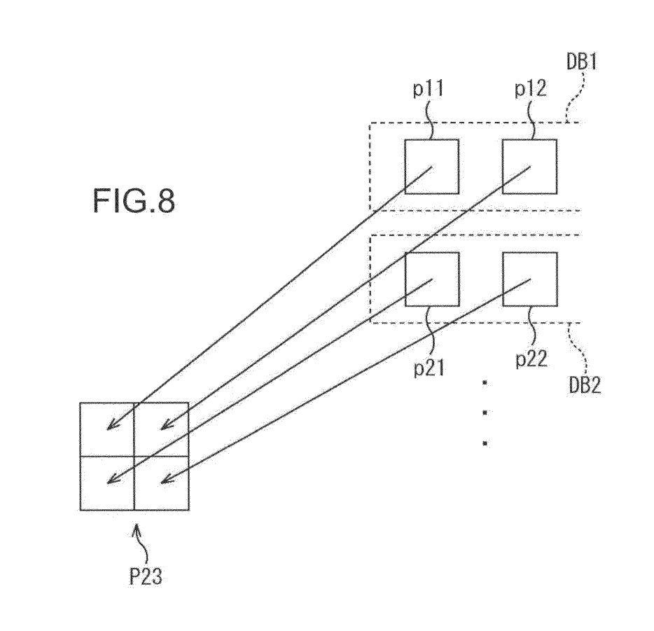

FIG. 7 is calculated, as shown in FIG. 8, based on the pixel data of the first and second pixels p11 and p12 from the left on the first line in the R image stored in the data buffer DB1, the pixel data of the first and second pixels p21 and p22 from the left on the second line in the R image stored in the data buffer DB2, and the occupation rate of each of the pixels.

Similarly, though not shown, pixel data of the fourth pixel P24 from the left on the second line of the output image shown in FIG. 7 is calculated based on the pixel data of the second and third pixels p12 and p13 from the left on the first line in the R image stored in the data buffer DB1, the pixel data of the second and third pixels p22 and p23 from the left on the second line in the R image stored in the data buffer DB2, and the occupation rate of each of the pixels.

It should be noted that pixel positions and occupation rates of the 2×2 adjacent pixels in the R image are calculated based on pixel positions and rotational misalignment angle θ of an output pixel.

In this way, in the processing of calculating the pixel data of the output pixels by sequentially reading out the pixel data stored in the data buffers DB1 to DB4, reading out the pixel data stored in the data buffer DB1 is completed when the pixel data for the fourth line in the output image are read out, and then pixel data on the fifth line in the R image are newly stored in the data buffer DB1. Similarly, reading out the pixel data stored in the data buffer DB2 is completed when the pixel data for the fifth line in the output image are read out, and then pixel data on the sixth line in the R image are newly stored in the data buffer DB2. Reading out the pixel data stored in the data buffer DB3 is completed when the pixel data for the sixth line in the output image are read out, and then pixel data on the seventh line in the R image are newly stored in the data buffer DB3. Reading out the pixel data stored in the data buffer DB4 is completed when the pixel data for the seventh line in the output image are read out, and then pixel data on the eighth line in the R image are newly stored in the data buffer DB4.

Accordingly, the physically-used buffer size for the buffer 32 in the example shown in FIG. 7 amounts to a buffer size, enclosed by the illustrated dashed line, which will store four lines.

Although, in the output image shown in FIG. 7, the pixels represented by squares of shaded areas represent the pixels constituting the blank regions, the pixels above a dashed line L between the third and fourth lines in the output image of FIG. 7 may represent the pixels constituting the blank regions in the output image.

In addition, if, in the example shown in FIG. 7, the pixel position of each output pixel in the output image and the pixel positions of 2×2 adjacent pixels in the R image are on the same line, storing the pixel data on the eighth line in the R image in the buffer 32 may be avoided using a delay buffer.

Moreover, in the output pixels of the output image shown in FIG. 7, the output to those portions (i.e., in FIG. 7, those lower halves of the output pixels of the output image which are enclosed by dashed line) for which the use of pixels on the same line as the lower pixels (for example, the pixels p21 and p22 shown in FIG. 8) of 2×2 adjacent pixels in the R image continues may be delayed, by a necessary number of pixels, using a delay buffer.

<3. Example 2 of Storing Pixel Data into a Buffer and Reading Out the Pixel Data from the Buffer>

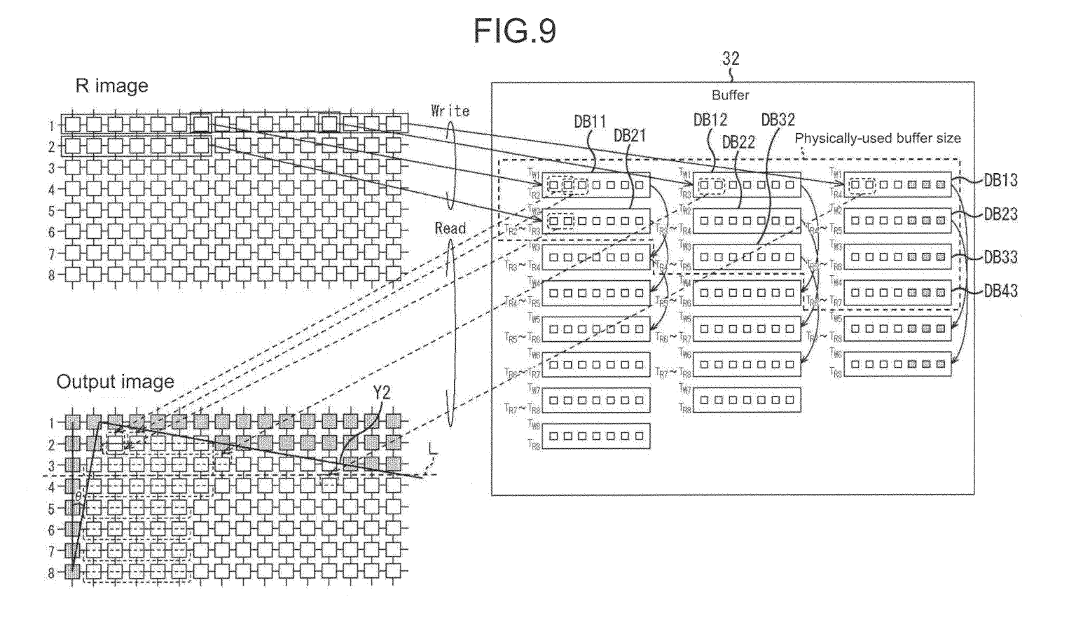

Referring next to FIG. 9, another example of storing the pixel data into the buffer 32 and reading out them from the buffer 32 will be described.

In FIG. 9, the pixel data of the pixels in the R image captured by the camera 21-2 are stored in the buffer 32 one after another of blocks of pixels (pixel blocks) corresponding to a given number of pixels constituting one line of the output image. In the example shown in FIG. 9, the first line of the R image is divided into three pixel blocks. Specifically, for example, pixel data in a pixel block (called “the first block” etc. below) that includes the first to seventh pixels on the first line in the R image are stored in a data buffer DB11, pixel data in the second block that includes the seventh to thirteenth pixels on the first line in the R image are stored in a data buffer DB12, and pixel data in the third block that includes the thirteenth to sixteenth pixels on the first line in the R image are stored in a data buffer DB13. Similarly, pixel data in each pixel block in the R image are stored in the corresponding one of data buffers DB21 to DB43.

It should be noted that in the example shown in FIG. 9, a storage location of each pixel data is predetermined based on a pixel position of the corresponding output pixel. This causes a reduction in computational complexity necessary for finding the pixel position of the corresponding output pixel.

On the other hand, the pixel data stored in the data buffers DB11 to DB43 are used for calculating pixel data of pixels represented by squares with a visible line and a transparent fill (pixels constituting the effective region Y2) among the pixels constituting the output image (rotated R image) and they are read out as needed. It should be noted that among all of the pixels constituting the output image, pixels represented by squares of shaded areas are pixels constituting the blank regions.

Similarly to FIG. 7, T_{Wn} (where n is a natural number) near the upper left corner of each of the data buffers DB11 to DB43 represents a timing at which the pixel data on the nth line in the R image are stored (or written) in the corresponding one of the data buffers DB1 to DB4, and T_{Rn} near the lower left corner of each of the data buffers DB11 to DB43 represents a timing at which pixel data constituting the nth line in the output image are read out (or read) from the corresponding data buffer.

Thus, for example, the pixel data in the first block on the first line in the R image are stored in the data buffer DB11 at the timing T_{W1} and the stored pixel data are read out at the timing T_{R2} for reading out pixel data constituting the second line in the output image.

In the processing of calculating the pixel data of the output pixels by sequentially reading out the pixel data stored in the data buffers DB11 to DB43, reading out the pixel data stored in the data buffer DB11 is completed when the pixel data for the second line in the output image are read out, and then pixel data on the third line in the R image are newly stored in the data buffer DB11. Similarly, reading out the pixel data stored in the data buffer DB21 is completed when the pixel data for the third line in the output image are read out, and then pixel data of pixels on the fourth line in the R image are newly stored in the data buffer DB21.

Reading out the pixel data stored in the data buffer DB12 is completed when the pixel data for the third line in the output image are read out, and then pixel data on the fourth line in the R image are newly stored in the data buffer DB12. Reading out the pixel data stored in the data buffer DB22 is completed when the pixel data for the fourth line in the output image are read out, and then pixel data on the fifth line in the R image are newly stored in the data buffer DB22. Reading out the pixel data stored in the data buffer DB32 is completed when the pixel data for the fifth line in the output image are read out, and then pixel data on the sixth line in the R image are newly stored in the data buffer DB32.

Reading out the pixel data stored in the data buffer DB13 is completed when the pixel data for the fourth line in the output image are read out, and then pixel data on the fifth line in the R image are newly stored in the data buffer DB13. Reading out the pixel data stored in the data buffer DB23 is completed when the pixel data for the fifth line in the output image are read out, and then pixel data on the sixth line in the R image are newly stored in the data buffer DB23.

In this way, in the example shown in FIG. 9, storage timing after completion of reading out from the data buffer is controlled one after another of the pixel blocks, providing a reduction in buffer size used as compared to the example shown in FIG. 7. In the example shown in FIG. 9, the physically-used buffer size for the buffer 32 amounts to a buffer size, enclosed by the illustrated dashed line in FIG. 9, which will store about three lines.

Although, in the output image shown in FIG. 9, the pixels represented by squares of shaded areas represent the pixels constituting the blank regions, the pixels above a dashed line L between the third and fourth lines in the output image of FIG. 9 may represent the pixels constituting the blank regions in the output image.

In addition, if, in the example shown in FIG. 9 also, the pixel position of each output pixel in the output image and the pixel positions of 2×2 adjacent pixels in the R image are on the same line, storing the pixel data on the eighth line in the R image in the buffer 32 may be avoided using a delay buffer.

Moreover, in the output pixels of the output image shown in FIG. 9, the output to those portions (i.e., in FIG. 9, those lower halves of the output pixels of the output image which are enclosed by dashed line) for which the use of pixels on the same line as the lower pixels (for example, the pixels p21 and p22 shown in FIG. 8) of 2×2 adjacent pixels in the R image continues may be delayed, by a necessary number of pixels, using a delay buffer.

<4. Example 3 of Storing Pixel Data into a Buffer and Reading Out the Pixel Data from the Buffer>

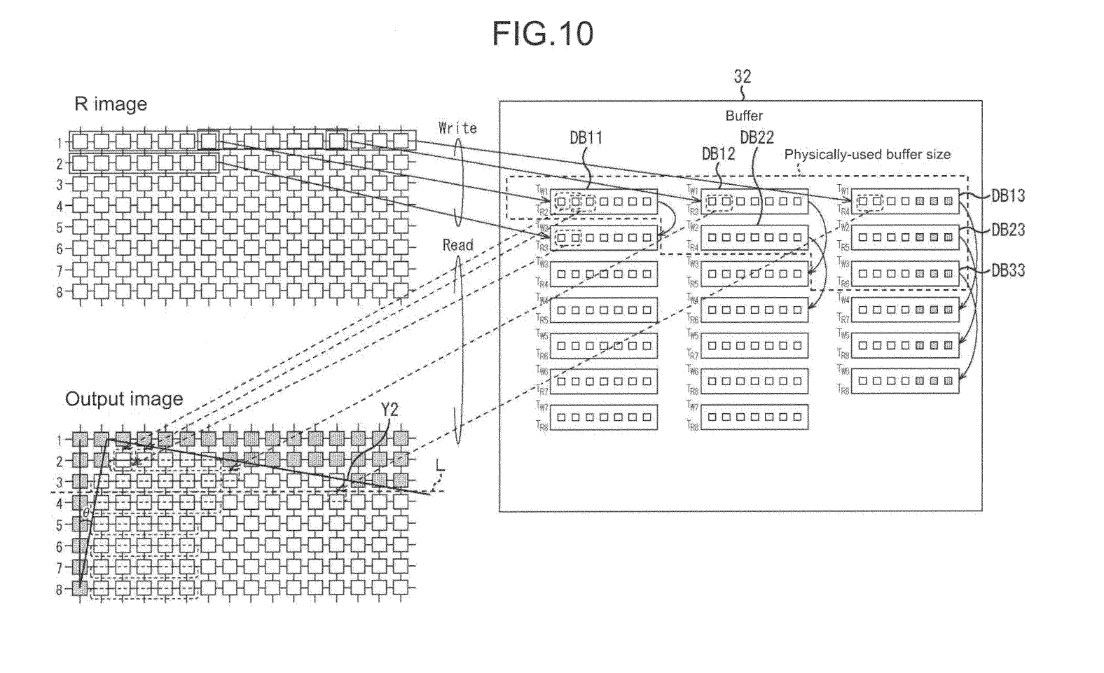

Referring next to FIG. 10, still another example of storing the pixel data into the buffer 32 and reading out them from the buffer 32 will be described.

In FIG. 10 also, the pixel data of the pixels in the R image captured by the camera 21-2 are stored in the buffer 32 one after another of blocks of pixels (pixel blocks) corresponding to a given number of pixels constituting one line of the output image. In the example shown in FIG. 10 also, the first line of the R image is divided into three pixel blocks. Specifically, for example, pixel data in a pixel block (called “the first block” below) that includes the first to seventh pixels on the first line in the R image are stored in a data buffer DB11, pixel data in the second block that includes the seventh to thirteenth pixels on the first line in the R image are stored in a data buffer DB12, and pixel data in the third block that includes the thirteenth to sixteenth pixels on the first line in the R image are stored in a data buffer DB13. Similarly, pixel data in each pixel block in the R image are stored in the corresponding one of data buffers DB22 to DB33.

It should be noted that in the example shown in FIG. 10 also, a storage location of each pixel data is predetermined based on a pixel position of the corresponding output pixel. This causes a reduction in computational complexity necessary for finding the pixel position of the corresponding output pixel.

On the other hand, the pixel data stored in the data buffers DB11 to DB33 are used for calculating pixel data of pixels represented by squares with a visible line and a transparent fill (pixels constituting the effective region Y2) among the pixels constituting the output image (rotated R image) and they are read out as needed. It should be noted that among all of the pixels constituting the output image, pixels represented by squares of shaded areas are pixels constituting the blank regions.

Similarly to FIG. 7, T_{Wn} (where n is a natural number) near the upper left corner of each of the data buffers DB11 to DB33 represents a timing at which the pixel data on the nth line in the R image are stored (or written) in the corresponding one of the data buffers DB11 to DB33, and T_{Rn} near the lower left corner of each of the data buffers DB11 to DB33 represents a timing at which pixel data constituting the nth line in the output image are read out (or read) from the corresponding data buffer.

Thus, for example, the pixel data in the first block on the first line in the R image are stored in the data buffer DB11 at the timing T_{W1} and the stored pixel data are read out at the timing T_{R2} for reading out pixel data constituting the second line in the output image.

Here, if, in the example shown in FIG. 10, the pixel position of each output pixel in the output image and the pixel positions of 2×2 adjacent pixels in the R image are on the same line, storage of the pixel data in the pixel blocks in the R image may be delayed using a delay buffer.

In other words, reading out the pixel data stored in the data buffer DB11 is completed when the pixel data for the second line in the output image are read out, and then pixel data on the second line in the R image are newly stored in the data buffer DB11. Delaying, at this time, the storage of the pixel data on the second line in the R image makes it possible to avoid overwriting before the pixel data for the second line in the output image are read out.

Similarly, reading out the pixel data stored in the data buffer DB12 is completed when the pixel data for the third line in the output image are read out, and then pixel data on the third line in the R image are newly stored in the data buffer DB12. Reading out the pixel data stored in the data buffer DB22 is completed when the pixel data for the fourth line in the output image are read out, and then pixel data on the fourth line in the R image are newly stored in the data buffer DB22.

Reading out the pixel data stored in the data buffer DB13 is completed when the pixel data for the fourth line in the output image are read out, and then pixel data on the fourth line in the R image are newly stored in the data buffer DB13. Reading out the pixel data stored in the data buffer DB23 is completed when the pixel data for the fifth line in the output image are read out, and then pixel data on the fifth line in the R image are newly stored in the data buffer DB23. Reading out the pixel data stored in the data buffer DB33 is completed when the pixel data for the sixth line in the output image are read out, and then pixel data on the sixth line in the R image are newly stored in the data buffer DB33.

In this way, in the example shown in FIG. 10, delaying the storage in the data buffer makes it possible to write in the data buffer whose stored data are being read out. This provides a more reduction in buffer size used as compared to the example shown in FIG. 9. In the example shown in FIG. 10, the physically-used buffer size for the buffer 32 amounts to a buffer size, enclosed by the illustrated dashed line in FIG. 10, which will store about two lines.

Although, in the output image shown in FIG. 10, the pixels represented by squares of shaded areas represent the pixels constituting the blank regions, the pixels above a dashed line between the third and fourth lines in the output image of FIG. 10 may represent the pixels constituting the blank regions in the output image.

Moreover, in the output pixels of the output image shown in FIG. 10, the output to those portions (i.e., in FIG. 10, those lower halves of the output pixels of the output image which are enclosed by dashed line) for which the use of pixels on the same line as the lower pixels (for example, the pixels p21 and p22 shown in FIG. 8) of 2×2 adjacent pixels in the R image continues may be delayed, by a necessary number of pixels, using a delay buffer.

As mentioned before, the pixel positions and occupation rates of the 2×2 adjacent pixels which correspond to an output pixel are calculated based on pixel positions and an angle θ of rotational misalignment of the output pixel, and they are expressed by point numbers because they are calculated using triangulation. Treating these values as fixed-point numbers allows approximate processing with a sufficiently good accuracy, causing a further increase of a calculation speed.

Because these values are calculated from the known parameters (angle of view and rotational misalignment angle θ of an image), these values may be calculated beforehand and retained in a table. This reduces the computational complexity for processing of storage and reading-out of pixel data, providing a further increase of a calculation speed.

The above description is made on the assumption that there is no positional misalignment in the xy directions between the L image and the R image, but the following description will be made on position adjustment of image taking such positional misalignment in the xy directions into consideration.

### <5. Another Structure and Operation of an Image Processing Apparatus According to Another Embodiment of the Present Technology>

### [The Structure of an Image Processing Apparatus]

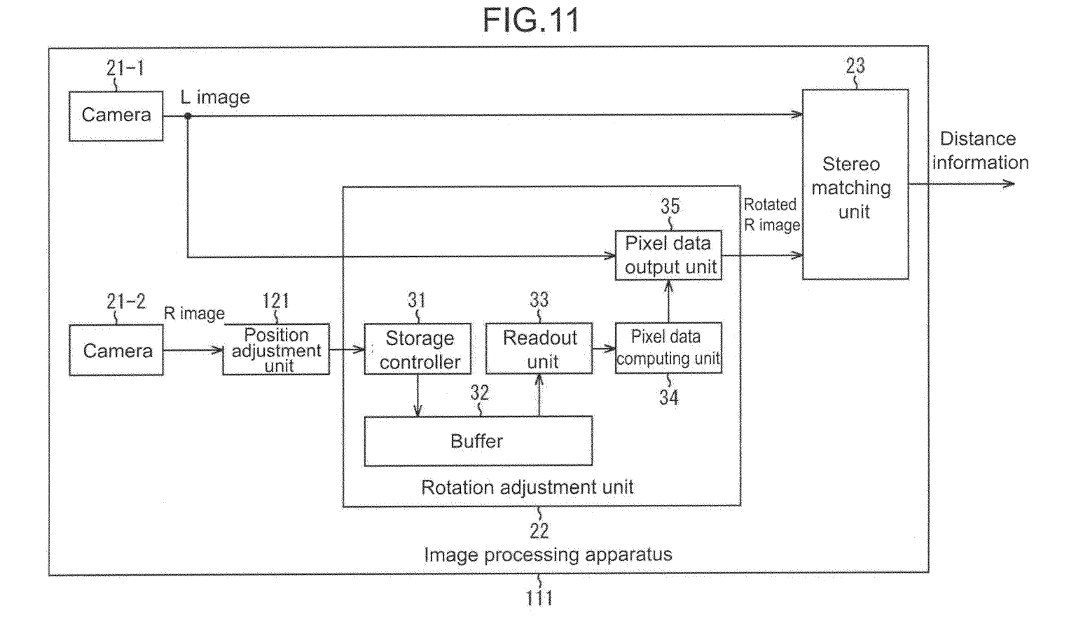

FIG. 11 illustrates a structure of an image processing apparatus (or image processing system) according to another embodiment of the present technology.

It should be noted that in the image processing apparatus 111 shown in FIG. 11, portions or parts having similar functions to those used in the image processing apparatus 11 shown in FIG. 1 are represented by the same names and reference numerals as those used in the image processing apparatus 11, and their description is omitted as needed.

In other words, the image processing apparatus 111 shown in FIG. 11 differs from the image processing apparatus 11 shown in FIG. 1 in that there is newly provided a position adjustment unit 121.

The position adjustment unit 121 rectifies a position in the xy directions of an R image captured by the camera 21-2 by adjusting an image sensor in the camera 21-2 in a way to change position to output each pixel and feeds the R image after position adjustment in the xy directions to the rotation adjustment unit 22.

### [Positional Misalignment of Image in xy Directions]

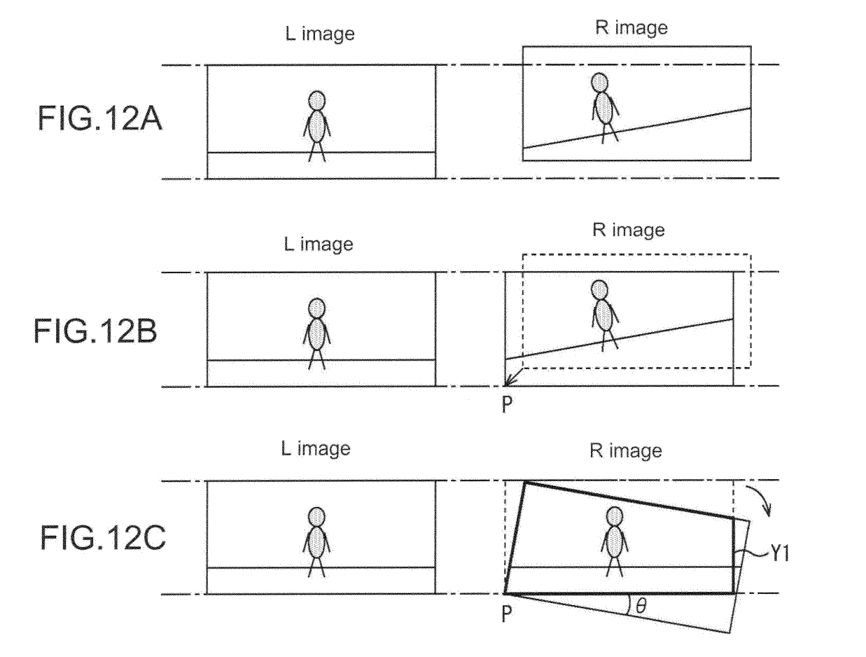

Now, referring to FIGS. 12A, 12B and 12C, positional misalignment of the R image relative to an L image in the xy directions will be explained.

FIG. 12A illustrates the L image taken by the camera 21-1 and the R image taken by the camera 21-2. As seen in FIG. 12A, assuming that the subject of the L image is a reference, the subject of the R image is inclined to the left with respect to the subject of the L image (or misaligned by a given angle)and includes positional misalignment in the xy directions.

FIG. 12B illustrates the same L image as that illustrated in FIG. 12A and the R image after rectifying the positional misalignment in the xy directions, which is included in the R image shown in FIG. 12A.

After rectifying the positional misalignment in the xy directions in this way, it is now made possible to obtain an angle θ of an inclination (a rotational misalignment) of the subject in the R image illustrated in FIG. 12A, as illustrated in FIG. 12C.

### [Position Adjustment Processing]

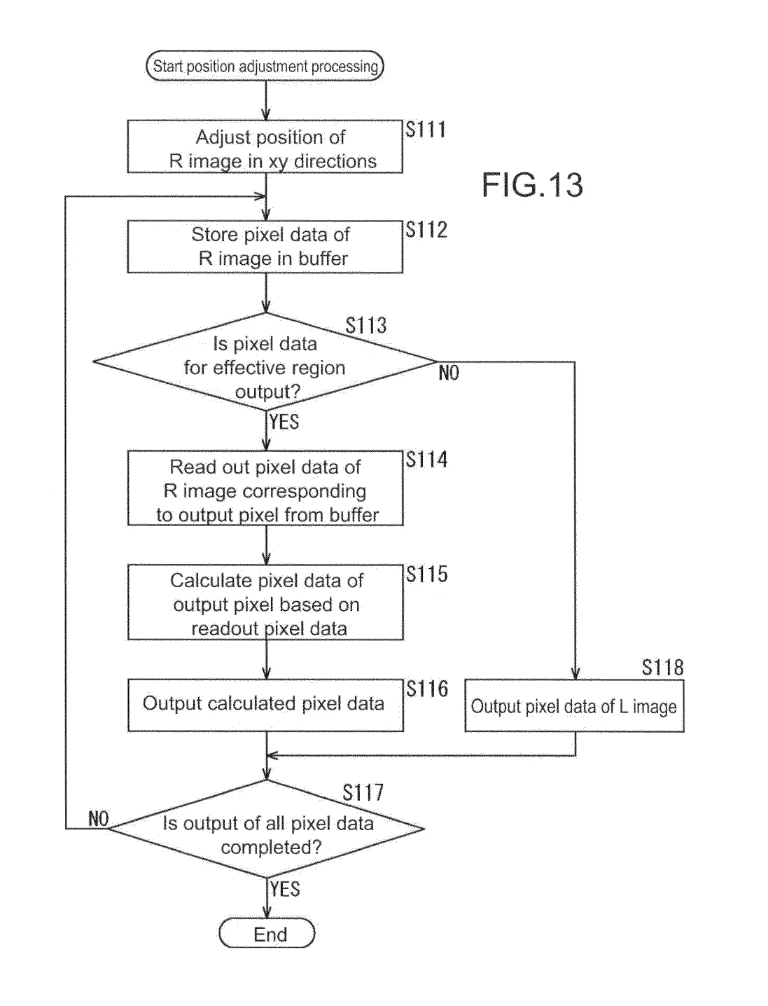

Referring, next, to the flowchart shown in FIG. 13, the position adjustment processing by the image processing apparatus 111 shown in FIG. 11 will be described.

Explanation of steps S112 to S117 of the flowchart shown in FIG. 13 is omitted because they are similar to the steps S11 to S16 of the flowchart shown in FIG. 6.

Specifically, in step S111, the position adjustment unit 121 rectifies a positional misalignment in the xy directions in the R image captured by the camera 21-2 and feeds the R image after position adjustment in the xy directions to the rotation adjustment unit 22.

The position adjustment processing shown in the flowchart of FIG. 13 and that shown in the flowchart of FIG. 6 provide similar effects.

It should be noted that in the preceding description, the L image is used as a reference image, but the R image may be used as a reference image.

In the present specification, the term “system” means a group including a plurality of constituent elements (apparatuses, modules (parts), and the like) and does not consider whether all of such constituent elements are within the same housing. Thus, the term “system” also means a plurality of apparatuses accommodated in different housings and connected by network and an apparatus in which a plurality of modules are accommodated in the same housing.

The above-described series of operations and calculations may be executed by hardware or software. If the series of operations and calculations are executed by software, a program constituting such software may be installed from a program recording medium into a computer built into hardware for exclusive use or into a general-purpose personal computer or the like capable of executing various functions by installing various programs.

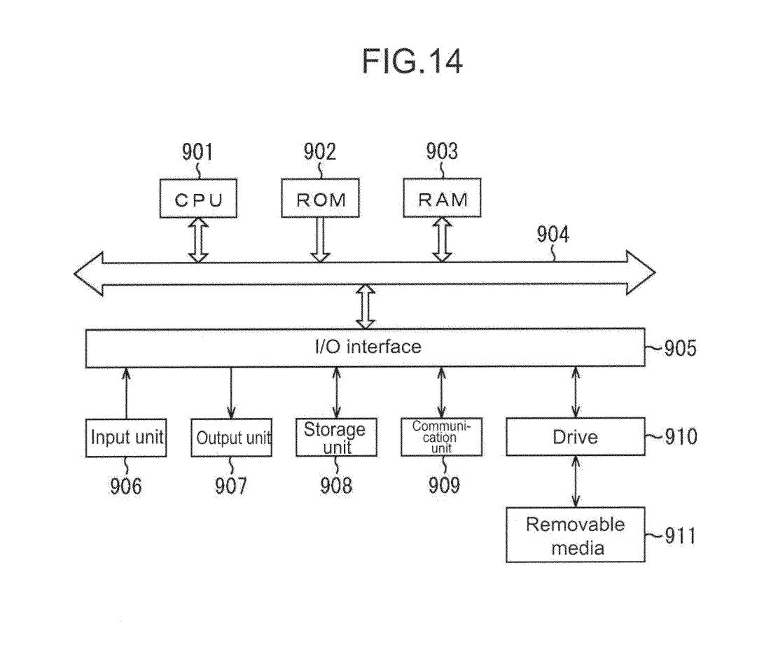

FIG. 14 is a block diagram illustrating a structural example of hardware of a computer which executes the above-mentioned series of operations and calculations by a program.

In the computer, a central processing unit (CPU) 901, a read only memory (ROM) 902, and a random access memory (RAM) 903 are interconnected by a bus 904.

Also connected to the bus 904 is an input/output (I/O) interface 905. Connected to the I/O interface 905 are an input unit 906 including a keyboard, a mouse, a microphone and the like, an output unit 907 including a display, a speaker and the like, a storage unit 908 including a hard disk, a non-volatile memory and the like, a communication unit 909 including a network interface and the like, and a drive 910 for driving removable media 911 including a magnetic disc, an optical disc, a magneto-optical disc, a semiconductor memory, and the like.

In the computer constructed as described above, the CPU 901 loads, for example, the stored program of the storage unit 908 into the RAM 903 via the I/O interface 905 and the bus 904 and executes the program, to thereby perform the above-described series of operations and calculations.

The program to be executed by the computer (CPU 901) is provided by storing it in, for example, the removable media 911 like package media which include a magnetic disc (including a flexible disc), an optical disc (a compact disc-read only memory (CD-ROM), a digital versatile disc (DVD) and the like), a magneto-optical disc, a semiconductor memory, and the like. Alternatively, the program may be provided via a wire or radio transmission medium such as a local area network, the Internet, or digital satellite broadcasting.

The program is installed in the storage unit 908 via the I/O interface 905 by putting the removable media 911 into the drive 910. Another method of installing the program is to provide the program via the wire or radio transmission medium to the communication unit 909 and cause the communication unit 909 to receive the program to install it in the storage unit 908. According to another method of installing the program, the program may be installed beforehand in the ROM 902 or the storage unit 908.

It should be noted that the program to be executed by the computer may be a program that performs time series processing in the order described in the specification or a program that performs operations and calculations in parallel or at a necessary timing when called.

Embodiments of the present technology are not limited to the above described embodiments and may involve any modifications within a range not deviated from the gist of the present technology.

For example, the present technology may take the form of cloud computing in which a plurality of apparatuses share one function or cooperate with each other to perform one function via a network.

An operation in each step of the above-described flowcharts may be executed by a single apparatus or shared by a plurality of apparatuses.

In addition, if a single step includes a plurality of operations, the plurality of operations in the single step may be executed by one apparatus or shared by a plurality of apparatuses.

The present technology may take the following form.
(1) An image processing apparatus for adjustment of relative positions of a plurality of images of the same subject, the image processing apparatus including:

a storage controller configured to store pixel data of pixels of an input image in a buffer, the input image being included in the plurality of images including a reference image that is a standard for the other images, the input image differing from the reference image in that the subject of the input image is misaligned from the subject of the reference image by a given angle;

a readout unit configured to read out, from the buffer, the pixel data of the pixels of the input image that fall in a region of the input image when rotated by the given angle, the region corresponding to the reference image; and

a pixel data computing unit configured to calculate pixel data of pixels constituting a rotated image, which includes the input image rotated by the given angle, based on the pixel data read out by the readout unit.
(2) The image processing apparatus according to item (1), in which

the pixels of the input image that fall in the region are scanned before corresponding pixels of the reference image are scanned.
(3) The image processing apparatus according to item (1) or (2), in which

the readout unit reads out from the buffer the pixel data of 2×2 adjacent pixels that are in the region of the input image and correspond to a pixel position of one pixel constituting the rotated image.
(4) The image processing apparatus according to any one of items (1) to (3), in which

the storage controller stores the pixel data of the pixels of the input image one line after another in the buffer.
(5) The image processing apparatus according to any one of items (1) to (3), in which

the storage controller stores the pixel data of the pixels of the input image one after another of pixel blocks in the buffer, each of the pixel blocks containing a given number of pixels constituting one line of the rotated image.
(6) The image processing apparatus according to item (5), in which

in a case where a line of pixels to be stored of the input image corresponds to a line of pixels of the rotated image that correspond to pixels to be read out in the input image, the storage controller delays storing pixel data of the pixels of the input image one after another of the pixel blocks in the buffer.
(7) The image processing apparatus according to any one of items (1) to (6), further including:

a pixel data output unit configured to output, as pixel data of pixels constituting the rotated image, pixel data of pixels falling a region in the reference image, the region falling outside the region of the input image when rotated by the given angle.
(8) The image processing apparatus according to any one of items (1) to (7), further including:

a position adjustment unit configured to rectify a positional misalignment in xy directions in the input image with respect to the reference image.
(9) An image processing method for an image processing apparatus used for adjustment of relative positions of a plurality of images of the same subject, the image processing method including:

storing pixel data of pixels of an input image in a buffer, the input image being included in the plurality of images including a reference image that is a standard for the other images, the input image differing from the reference image in that the subject of the input image is misaligned from the subject of the reference image by a given angle;

reading out, from the buffer, the pixel data of the pixels of the input image that fall in a region of the input image when rotated by the given angle, the region corresponding to the reference image; and

calculating pixel data of pixels constituting a rotated image, which includes the input image rotated by the given angle, based on the pixel data read out.
(10) A program causing a computer to perform image processing for adjustment of relative positions of a plurality of images of the same subject, the program causing the computer to execute the steps of:

storing pixel data of pixels of an input image in a buffer, the input image being included in the plurality of images including a reference image that is a standard for the other images, the input image differing from the reference image in that the subject of the input image is misaligned from the subject of the reference image by a given angle;

reading out, from the buffer, the pixel data of the pixels of the input image that fall in a region of the input image when rotated by the given angle, the region corresponding to the reference image; and

calculating pixel data of pixels constituting a rotated image, which includes the input image rotated by the given angle, based on the pixel data read out by the reading out from the buffer.
(11) An image processing system for adjustment of relative positions of a plurality of images of the same subject, the image processing system including:

a plurality of cameras configured to capture a plurality of images of the same subject,; and

an image processing apparatus including
a storage controller configured to store pixel data of pixels of an input image in a buffer, the input image being included in the plurality of images including a reference image that is a standard for the other images, the input image differing from the reference image in that the subject of the input image is misaligned from the subject of the reference image by a given angle,
a readout unit configured to read out, from the buffer, the pixel data of the pixels of the input image that fall in a region of the input image when rotated by the given angle, the region corresponding to the reference image, and
a pixel data computing unit configured to calculate pixel data of pixels constituting a rotated image, which includes the input image rotated by the given angle, based on the pixel data read out by the readout unit.

The present disclosure contains subject matter related to that disclosed in Japanese Priority Patent Application JP 2011-185719 filed in the Japan Patent Office on Aug. 29, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus for adjustment of relative positions of a plurality of images of the same subject, the image processing apparatus comprising:
a storage controller configured to store pixel data of pixels of an input image in a buffer, the input image being included in the plurality of images including a reference image that is a standard for the other images, the input image differing from the reference image in that the subject of the input image is misaligned from the subject of the reference image by a given angle;
a readout unit configured to read out, from the buffer, the pixel data of the pixels of the input image that fall in a region of the input image when rotated by the given angle, the region corresponding to the reference image; and
a pixel data computing unit configured to calculate pixel data of pixels constituting a rotated image, which includes the input image rotated by the given angle, based on the pixel data read out by the readout unit.

2. The image processing apparatus according to claim 1, wherein
the pixels of the input image that fall in the region are scanned before corresponding pixels of the reference image are scanned.

3. The image processing apparatus according to claim 1, wherein
the readout unit reads out from the buffer the pixel data of 2×2 adjacent pixels that are in the region of the input image and correspond to a pixel position of one pixel constituting the rotated image.

4. The image processing apparatus according to claim 3, wherein
the storage controller stores the pixel data of the pixels of the input image one line after another in the buffer.

5. The image processing apparatus according to claim 3, wherein
the storage controller stores the pixel data of the pixels of the input image one after another of pixel blocks in the buffer, each of the pixel blocks containing a given number of pixels constituting one line of the rotated image.

6. The image processing apparatus according to claim 5, wherein
in a case where a line of pixels to be stored of the input image corresponds to a line of pixels of the rotated image that correspond to pixels to be read out in the input image, the storage controller delays storing pixel data of the pixels of the input image one after another of the pixel blocks in the buffer.

7. The image processing apparatus according to claim 1, further comprising
a pixel data output unit configured to output, as pixel data of pixels constituting the rotated image, pixel data of pixels falling a region in the reference image, the region falling outside the region of the input image when rotated by the given angle.

8. The image processing apparatus according to claim 1, further comprising
a position adjustment unit configured to rectify a positional misalignment in xy directions in the input image with respect to the reference image.

9. An image processing method for an image processing apparatus used for adjustment of relative positions of a plurality of images of the same subject, the image processing method comprising:
storing pixel data of pixels of an input image in a buffer, the input image being included in the plurality of images including a reference image that is a standard for the other images, the input image differing from the reference image in that the subject of the input image is misaligned from the subject of the reference image by a given angle;
reading out, from the buffer, the pixel data of the pixels of the input image that fall in a region of the input image when rotated by the given angle, the region corresponding to the reference image; and
calculating pixel data of pixels constituting a rotated image, which includes the input image rotated by the given angle, based on the pixel data read out.

10. A program causing a computer to perform image processing for adjustment of relative positions of a plurality of images of the same subject, the program causing the computer to execute the steps of:
storing pixel data of pixels of an input image in a buffer, the input image being included in the plurality of images including a reference image that is a standard for the other images, the input image differing from the reference image in that the subject of the input image is misaligned from the subject of the reference image by a given angle;
reading out, from the buffer, the pixel data of the pixels of the input image that fall in a region of the input image when rotated by the given angle, the region corresponding to the reference image; and
calculating pixel data of pixels constituting a rotated image, which includes the input image rotated by the given angle, based on the pixel data read out by the reading out from the buffer.

11. An image processing system for adjustment of relative positions of a plurality of images of the same subject, the image processing system comprising:
a plurality of cameras configured to capture a plurality of images of the same subject,; and
an image processing apparatus including
a storage controller configured to store pixel data of pixels of an input image in a buffer, the input image being included in the plurality of images including a reference image that is a standard for the other images, the input image differing from the reference image in that the subject of the input image is misaligned from the subject of the reference image by a given angle,
a readout unit configured to read out, from the buffer, the pixel data of the pixels of the input image that fall in a region of the input image when rotated by the given angle, the region corresponding to the reference image, and
a pixel data computing unit configured to calculate pixel data of pixels constituting a rotated image, which includes the input image rotated by the given angle, based on the pixel data read out by the readout unit.
